(19) United States
(12) Patent Application Publication
(10) Pub. No.: US 2007/0174420 A1
(43) Pub. Date: Jul. 26, 2007

(54) Caching of web service requests

(75) Inventors: Darshanand Khusial, Mississauga (CA); Alex Shum, Thornhill (CA); Jacob Vandergoot, Bradford (CA)

Correspondence Address: DUKE W. YEE, YEE & ASSOCIATES, P.C., P.O. BOX 802333, DALLAS, TX, 75380, US

(73) Assignee: International Business Machines Corporation, Armonk, NY (US)

(21) Appl. No.: 11/337,984

(22) Filed: Jan. 24, 2006

(51) Int. Cl. G06F 15/16

(52) U.S. Cl. 709/217

(57) ABSTRACT

A computer implemented method, system, and computer program product for generating a response to a web service request from a requester. In response to receiving a web service request, a web service controller calls a business logic interface associated with the request. The output of the business logic interface can either be obtained from a cache or derived from the business logic interface. A customizable template is executed to generate the response to the request. A determination is made as to whether the response comprises a set of cacheable content. In response to determining that the response comprises a set of cacheable content, the set of cacheable content is stored in the cache. The response is sent to the requester.

### BACKGROUND OF THE INVENTION

1. Field of the Invention

The present invention relates generally to an improved data processing system and, in particular, to a method, system, and computer program product for processing web service requests. Still more particularly, the present invention relates to an improved computer implemented method, system, and computer program product for caching of web service requests.

2. Description of the Related Art

Legacy applications can be integrated into newly developed data processing systems and applications by utilizing a web service. A web service is an application provided by a web service server. A web service can be invoked with an extensible markup language (XML) request received over a variety of different Internet protocols, such as hypertext transfer protocol (HTTP).

A web service runtime interface, which can be layered directly on top of a legacy application, can act as a mediator that transforms an external extensible markup language (XML) request to an application programming interface (API) call to execute the legacy application. The web service runtime returns the output of the legacy application as an XML message wrapped in a simple object access protocol (SOAP) envelope.

Current web service implementations only support an all-or-nothing approach to caching web service responses. No existing approaches are available to handle a fragment approach where pieces of the response can be cached. Furthermore, specifying that a web service request should be cacheable on a particular set of parameters is not currently supported either.

The lack of fragment caching ability in web services can result in scalability and performance problems. For example, when a request is received that is only partially cacheable, the web service will not cache any part of the response. Each time the same non-cacheable request is received, the web service will re-generate the entire response. This process can be particularly burdensome if an application causes the web service to be exposed on the Internet where it could be accessed simultaneously by thousands or millions of clients.

Finally, web service implementations typically embed the response generation logic directly into the business logic of the web service application. In order to customize a response, the actual web service program code is modified. Thus, extensions of the web service response have to be designed with a high importance of documentation to describe how to integrate with the programming model. Therefore, modifying an existing implementation of a web service to improve performance or customize a response can be impractical or burdensome due to the expense of hiring a programmer skilled in the programming model of the web service.

### BRIEF SUMMARY OF THE INVENTION

The aspects of the present invention provide a computer implemented method, system, and computer program product for generating a response to a web service request from a requestor. In response to receiving a web service request, a web service controller calls a business logic interface associated with the request. The output of the interface can either be obtained from a cache or derived from the interface. A customizable template is executed to generate the response to the request. A determination is made as to whether the response comprises a set of cacheable content. In response to determining that the response comprises a set of cacheable content, the set of cacheable content is stored in the cache. The response is sent to the requester.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary pictorial representation of a network of data processing systems in which aspects of the present invention may be implemented;

FIG. 2 is an exemplary block diagram of a data processing system in which aspects of the present invention may be implemented;

FIG. 3 is an exemplary block diagram of a web services server in accordance with one exemplary embodiment of the present invention;

FIG. 4 is an exemplary illustration of a message flow during web service request processing in accordance with one exemplary embodiment of the present invention;

FIG. 5 is a flowchart outlining an exemplary operation of the present invention when a web service request is initially received from a requester in accordance with one exemplary embodiment of the present invention;

FIG. 6 is an exemplary illustration of XML code for mapping a web service request to a legacy application programming interface in accordance with one exemplary embodiment of the present invention;

FIG. 7 is a flowchart outlining an exemplary operation of the present invention when a legacy application is executed in accordance with one exemplary embodiment of the present invention;

FIG. 8 is a flowchart outlining an exemplary operation of the present invention when a determination is made as to whether to execute legacy application in accordance with one exemplary embodiment of the present invention;

FIG. 9 is an exemplary illustration of XML code when a read-only request is received in accordance with one exemplary embodiment of the present invention;

FIG. 10 is a flowchart outlining an exemplary operation of the present invention when a response is generated in accordance with one exemplary embodiment of the present invention;

FIG. 11 is a flowchart outlining an exemplary operation of the present invention when a web service response is cached in accordance with one exemplary embodiment of the present invention; and

FIG. 12 is an exemplary illustration of XML code when a response is generated utilizing fragment caching in accordance with one exemplary embodiment of the present invention.

### DETAILED DESCRIPTION OF THE INVENTION

As will be appreciated by one of skill in the art, the present invention may be embodied as a method, system, or computer program product. Accordingly, the present invention may take the form of an entirely software embodiment (including firmware, resident software, micro-code, etc.) or an embodiment combining software and hardware aspects all generally referred to herein as a “circuit” or “module.” Furthermore, the present invention may take the form of a computer program product on a computer-usable storage medium having computer-usable program code embodied in the medium.

Any suitable computer useable or readable medium may be utilized. The computer-usable or computer-readable medium may be, for example but not limited to, an electronic, magnetic, optical, electromagnetic, infrared, or semiconductor system, system, device, or propagation medium. More specific examples (a nonexhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, system, or device.

Computer program code for carrying out operations of the present invention may be written in an object oriented programming language such as Java7, Smalltalk or C++. However, the computer program code for carrying out operations of the present invention may also be written in conventional procedural programming languages, such as, for example, the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, systems, and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

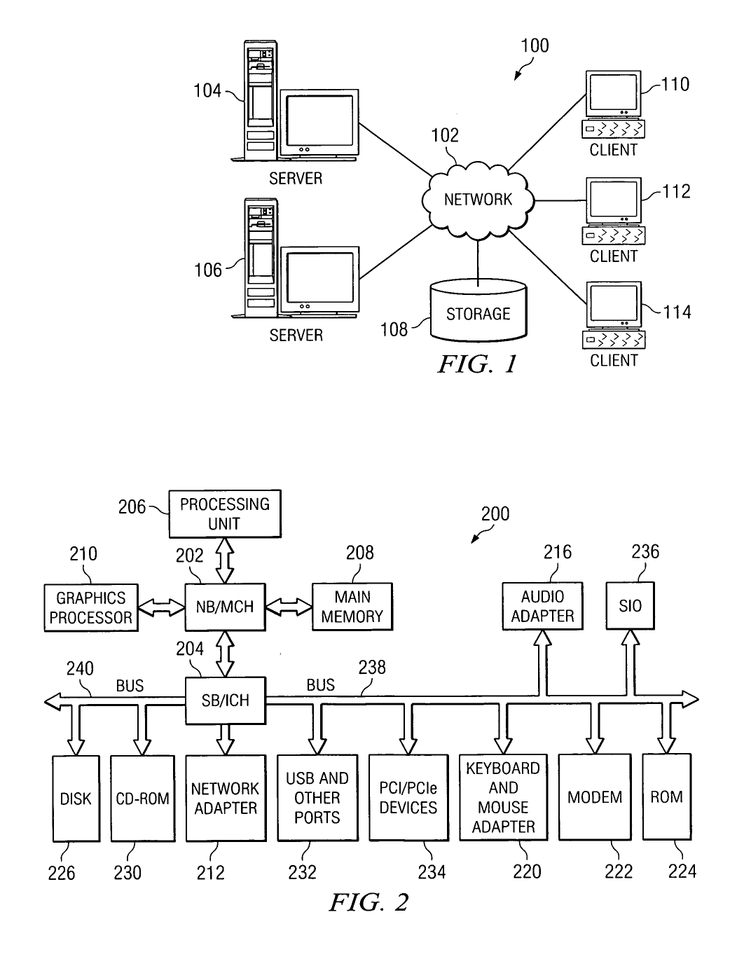

With reference now to the figures and in particular with reference to FIGS. 1-2, exemplary diagrams of data processing environments are provided in which embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of a network of data processing systems in which aspects of the present invention may be implemented. Network data processing system 100 is a network of computers in which embodiments of the present invention may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In accordance with the aspects of the present invention, server 102 and 104 are web service servers. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In accordance with this illustrative example, clients 110, 112, and 114 transmit a web service request to a server, such as servers 102 and 104 via network 102. In response, web service server, such as servers 102 and 104, send a web service response to the client requester, such as clients 110, 112, and 114 via network 102.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments of the present invention.

With reference now to FIG. 2, a block diagram of a data processing system is shown in which aspects of the present invention may be implemented. Data processing system 200 is an example of a computer, such as server 104 or client 110 in FIG. 1, in which computer usable code or instructions implementing the processes for embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206 and coordinates and provides control of various components within data processing system 200 in FIG. 2. As a client, the operating system may be a commercially available operating system such as Microsoft Windows XP (Microsoft and Windows are trademarks of Microsoft Corporation in the United States, other countries, or both). An object-oriented programming system, such as the Java® programming system, may run in conjunction with the operating system and provides calls to the operating system from Java® programs or applications executing on data processing system 200 (Java is a trademark of Sun Microsystems, Inc. in the United States, other countries, or both).

As a server, data processing system 200 may be, for example, an IBM® eServer™ pSeries® computer system, running the Advanced Interactive Executive (AIX®) operating system or the LINUX® operating system (eServer, pSeries and AIX are trademarks of International Business Machines Corporation in the United States, other countries, or both while LINUX is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for embodiments of the present invention are performed by processing unit 206 using computer usable program code, which may be located in a memory such as, for example, main memory 208, ROM 224, or in one or more peripheral devices 226 and 230.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the present invention may be applied to a multiprocessor data processing system.

In some illustrative examples, data processing system 200 may be a personal digital assistant (PDA), which is configured with flash memory to provide non-volatile memory for storing operating system files and/or user-generated data.

A bus system may be comprised of one or more buses, such as bus 238 or bus 240 as shown in FIG. 2. Of course, the bus system may be implemented using any type of communication fabric or architecture that provides for a transfer of data between different components or devices attached to the fabric or architecture. A communication unit may include one or more devices used to transmit and receive data, such as modem 222 or network adapter 212 of FIG. 2. A memory may be, for example, main memory 208, ROM 224, or a cache such as found in NB/MCH 202 in FIG. 2. The depicted examples in FIGS. 1-2 and above-described examples are not meant to imply architectural limitations. For example, data processing system 200 also may be a tablet computer, laptop computer, or telephone device in addition to taking the form of a PDA.

Currently, the most commonly employed method of transferring data over the Internet is to employ the World Wide Web environment, also called simply “the Web”. In the Web environment, servers and clients, such as servers 102 and 104 and clients 110-114 in FIG. 1, effect data transaction using the Hypertext Transfer Protocol (HTTP), a known protocol for handling the transfer of various data files. Examples of these types of data files include text, still graphic images, audio, and motion video. The information in various data files is formatted for presentation to a user by a standard page description language, the Hypertext Markup Language (HTML) or Extensible Markup Language (XML).

A web service is an application provided by a web service server. A web service provides an XML interface that enables application business logic to be accessible to users via different types of Internet protocols, including, but not limited to, standard Internet protocols such as hypertext transfer protocol (HTTP).

Many legacy applications need to be integrated into new data processing systems. The software industry's solution to integrating discrete systems and applications is to provide a web service interface to a legacy application's existing logic. Any type of application can be made available as a web service in this manner.

The aspects of the present invention recognize that web service performance problems can occur because current web service implementation and web service runtime only support an all-or-nothing approach to caching web service requests. No existing approaches are available to handle a fragment cache approach of servicing a web service request where elements of the response can be derived from cache. Furthermore, this model also does not support specifying that a request should be cacheable on a particular set of parameters.

Finally, modifying the existing implementation of a legacy application programming interface to improve performance or to modify the web service framework to customize a response format can be impractical due to the expense of hiring a programmer skilled in the particular programming model of the legacy application.

The aspects of the present invention provide an improved computer implemented method, system, and computer usable program code for caching of web service requests. In accordance with the embodiments of the present invention, a web service is provided in which multiple cache points are available during the process of generating a web service response. A web service controller acts as a mediator to transform an external XML request from a client requester into a call to execute a legacy application programming interface associated with a web service legacy application. The output of the legacy application programming interface can be stored in a cache. Moreover, the business logic interface associated with the legacy application is decoupled from the response generation logic utilized to generate a response to the web service request. In this manner, additional cache points are provided for caching the response.

The aspects of the present invention also provide a customizable template that is executed to generate a response to a web service request. The customizable template can be saved in cache. In addition, if the generated response is cacheable, the response can be saved in cache. Even if the entire response is not cacheable, one or more fragments of the response can be saved in cache, in accordance with a fragment cache approach. The response derived from cache or generated by executing the template is returned to the requesting client as an XML response message.

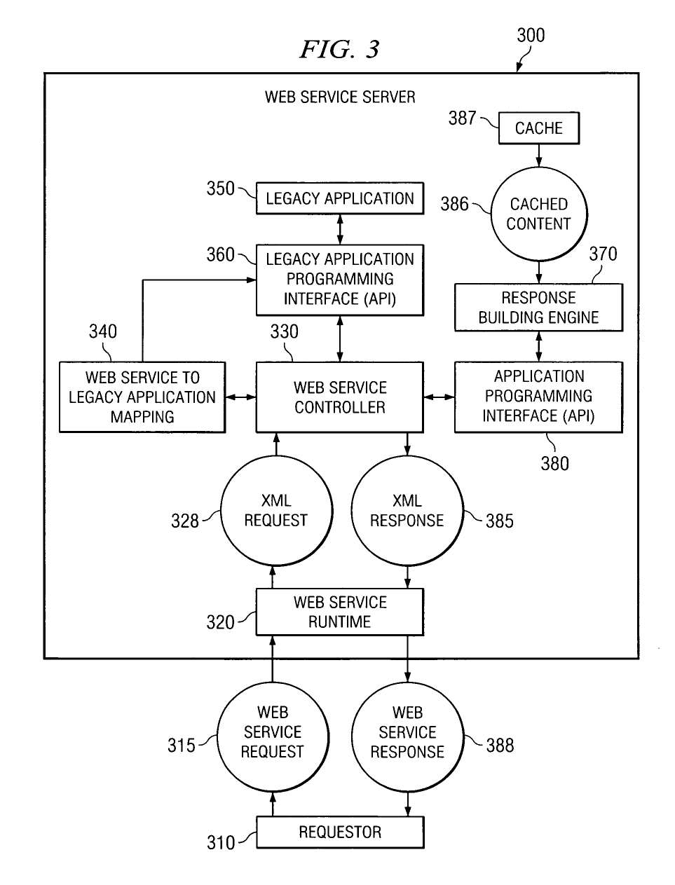

FIG. 3 is an exemplary block diagram of a web service server in accordance with one exemplary embodiment of the present invention. Web service server 300 is a server, such as servers 104 and 106 in FIG. 1. Requestor 310 is a requestor of a web service. Requestor 310 may access a web service in any web environment, including the Internet, intranet, or an extranet. In addition, requestor 310 can be a user, another application program, or even another web service. In accordance with one embodiment of the present invention, requestor 310 is a client accessing the web server.

A web service application may be invoked by requestor 310 in many different ways. In accordance with the aspects of the present invention, requestor 310 may make a web service request to invoke a web service by using any known or available method for invoking a web service. For example, in accordance with a traditional deployment model, a published web service definition language (WSDL) on a central web service server defines the services supported by that web service. In accordance with this example, a client, such as clients 110-114 in FIG. 1, can invoke a web service by connecting to the central web service server and requesting any web service application defined by the publicly available web service definition language.

A web service request 315 comprises an XML request wrapped in a simple object access protocol envelope. The simple object access protocol envelope provides information regarding how to process the XML request.

Web service runtime 320 receives web service request 315 from requestor 310. Web service runtime 320 handles the web protocols and processes the request in accordance with the simple object access protocol elements encapsulating the request. Web service runtime 320 extracts the XML request of web service request 315 from the simple object access protocol envelope to form XML request 328.

Web service runtime supports an all-or-nothing caching approach for web service requests, such as XML request 328. Therefore, if XML request 328 is cacheable, web service runtime 320 determines whether an XML response to XML request 328 is stored in cache. If XML response 385 to XML request 328 is stored in cache, web service runtime 320 retrieves the cached XML response 385. Web service runtime encloses XML response 328 in a simple object access protocol to form web service response 388 and transmits web service response 388 to requester 310 without executing the web service processes for generating a response.

However, because web service runtime only supports an all-or-nothing approach to caching, web service request will only be stored in cache if the entire web service request and response is cacheable. If XML response 385 is not stored in cache, web service runtime 320 forwards XML request 328 to web service controller 330 for processing of XML request 328 to generate XML response 385.

Web service controller 330 is a model view controller (MVC) framework for processing XML requests. Upon receiving XML request 328 from web service runtime 320, web service controller 330 calls web service to legacy application mapping 340 to map XML request 328 onto legacy application programming interface 360 associated with legacy application 350.

In the illustrative example shown here, interface 360 is an application programming interface associated with a legacy application. Legacy application programming interface is a business logic interface between a web service controller and an application business logic. In accordance with the aspects of the present invention, interface 360 can be any type of interface capable of serving as an interface between a web service controller and an application business logic.

Web service to legacy application mapping 340 generates parameters for a call to legacy application programming interface 360. Legacy application programming interface (API) 360 allows web service controller 330 to invoke execution of legacy application 350 using a standard consistent interface without concern for how the particular functionality of legacy application 350 is implemented. Web service controller 330 calls legacy application programming interface 360 utilizing the call format provided by web service to legacy application mapping 340.

Legacy application 350 represents any number of software applications designed to react to data through a communications port to provide the desired functionality requestor 310 seeks. In these examples, legacy application 350 can be any type of application. For example, applications at this level may include those necessary to handle data or text which can be accessed by clients of the Internet through a request to web service server 300.

Web service controller 330 receives the format for a call to legacy application programming interface 360 from mapping 340. Web service controller 330 determines if the output from legacy application programming interface 360 is stored in at least one of a cache. If the output is stored in cache, web service controller 330 retrieves the cached legacy application programming interface output from cache. Web service controller 330 forwards the cached legacy application programming interface output to application programming interface 380 associated with response building engine 370.

If web service controller 330 determines that the output of legacy application programming interface 360 is not stored in cache, web service controller 330 calls legacy application programming interface 360 to initiate execution of legacy application 350. Legacy application programming interface 360 returns output generated by execution of legacy application 350 to web service controller 330. Web service controller 330 forwards the output received from legacy application programming interface 360 to application programming interface 380 associated with response building engine 370.

Web service controller 330 then calls application program interface 380 to execute response building engine 370. Response building engine 370 generates a response to an XML request, such as XML response 385. Response building engine 370 generates an XML response based on information received by response building engine 370 that is relevant to the particular request. Response building engine 370 can generate an XML response based upon any available and/or relevant data. For example, response building engine 370 can generate a response based, in whole or in part, on the output received from legacy application programming interface 360. In addition, the XML response can be generated based on information available in a database or other data storage device, as well as parameters in the response template itself.

Response building engine 370 comprises a customizable response template. Response building engine 370 executes the response template to generate XML response 385 to XML request 328 based on a format specified in the template of response building engine 370. In addition, the template can be stored in cache. Thus, if a determination is made that the template is cacheable and available in cache, the response template can be derived from one of a cache for execution to generate XML response 328.

Response building engine 370 may be created using any programming language to code a response template in accordance with the aspects of the present invention. In accordance with an exemplary embodiment of the present invention, response building engine is a template language such as JavaServer® Pages (JSP) or Apache® Velocity. Of course, response building engine 370 can comprise other types of template languages, as well. Moreover, response building engine 360 can also comprise any other programming language, even languages that are not template languages. For example, response building engine 370 can be coded in C programming language, as well.

Response building engine 370 supports both complete caching of the response and fragment caching of portions of the response. Response building engine 370 caches the response in accordance with a caching policy specified in the response building engine 370.

If the response for XML request 328 is stored in cache, response building engine 370 retrieves the response from cache. Response building engine 370 generates an XML response, such as XML response 385 based on the cached response. Response generating engine 370 forwards XML response 385 to web service controller 330.

If the entire response for generating a response to XML request 328 is not stored in cache, response building engine 370 determines if one or more fragments of the response are stored in cache. If one or more fragments of the response are stored as cached content 386 in cache 387, response generating engine 370 retrieves cached content 386 from cache 387 rather than re-executing the template fragments associated with cached content 386.

A cacheable response is a complete XML response that can be stored in a cache. Rather than generating a cacheable response that is available in cache, the XML response can be derived from cache.

A single cacheable response fragment is a part or portion of a response that can be stored in cache. Multiple cacheable response fragments comprise multiple parts or portions of an XML response that can be stored in cache. Likewise, a cached response fragment is a portion or piece of an XML response that is currently stored in cache.

As used herein, a set of cacheable content can include a complete cacheable response, a single cacheable response fragment, or multiple cacheable response fragments. A set of cacheable content comprises a static portion of a response. A static portion of a response is a portion of a response that is updated or modified relatively infrequently. In contrast, a dynamic portion of a response is updated or modified relatively frequently.

For example, if a web service request is received requesting a description of available products and a current inventory of those products, the description of available products would probably be updated relatively infrequently, such as weekly, monthly, yearly, or possibly never. Therefore, the description of available products would comprise a static portion of the response. This information could be cacheable content available in cache. However, the current inventory of available products would likely require frequent updating to reflect changes in product availability. Therefore, the current inventory would comprise a dynamic content of the response.

Response building engine 370 executes the template fragments associated with response fragments that are not stored in cache to form a set of dynamic content. Response building engine 370 retrieves cached response fragments from cache to form a set of cached content 386. Response generating engine 370 generates a response to the request based upon the set of dynamic content and the set of cached content.

In accordance with the aspects of the present invention, response building engine 370 is a customizable template that can be modified to change the format of a response generated by execution of the template and/or to modify the caching policy for the response. A customizable template can be modified and/or updated by opening the template text file and modifying the template code in accordance with any known or available methods for updating and/or modifying a template text file.

For example, a user can modify response building engine 310 to cache specified fragments or portions of an XML response rather than caching the entire response. In this manner, the user can specify which portions of the response are cached and which portions of a response are dynamically determined during generation of the response. The customizable template can be updated or modified in accordance with any known or available methods for updating a template.

The template simplifies customization of the response generation by exposing the XML response such that the generated response is readable. For example, if the template language is a JavaServer® Pages template language, a user can modify the template language file to insert additional XML elements in the response rather than having to modify the programming language of the web service model. In this manner, the template language allows for easy extension of the response.

Application programming interface 380 allows web service controller 330 to invoke response building engine 370 using a standard consistent interface. The parameters of the call specify information regarding processing of the web service response 388.

Upon receiving XML response 385 generated by response building engine 370, web service controller 330 passes XML response 385 to web service runtime 320. Web service runtime 320 encapsulates XML response 385 in a simple object access protocol envelope to form a web service response 388 and transmits response 388 back to requestor 310 via the network.

In accordance with the exemplary illustration shown in FIG. 3, web service request 315 is transmitted to web service server 300 from a requester 310. Web service runtime 320 receives web service request 315 and handles the simple object access protocol envelope defining the request. Web service runtime 320 passes XML request 328 to web service controller 330. Web service controller 330 calls web service to legacy application mapping 340 to map the web service to legacy application programming interface 360. Mapping 340 generates a call format to legacy application programming interface 360 to execute legacy application 350.

Web service controller 330 receives output of execution of legacy application from legacy application programming interface 360. Web service controller 330 calls application programming interface 380 to execute response building engine 370 to generate a response based upon the output of legacy application processing interface 360.

Response building engine 370 can receive a set of cached content 386 from cache 387. As used herein, the set of cached content can include the entire response, a single response fragment, or two or more response fragments stored in cached. Response building engine 370 also executes a response template to generate a set of dynamic content. As used herein, dynamic content can include the entire response, a response fragment, or two or more response fragments. Response building engine 370 generates XML response 385 based on the set of cached content and the set of dynamic content.

Web service controller 330 sends XML response 385 generated by response building engine 370 to web service runtime 320. Web service runtime 320 encloses XML response 385 in a simple object access protocol envelop to form web service response 388. Web service runtime 320 transmits web service response 388 to requester 310 via the web.

In accordance with an embodiment of the present invention, legacy application 350 and web service to legacy application mapping 340 can be embodied within the same component.

In accordance with an illustrative example of the present invention, if legacy application is available in cache, web service controller 330 does not call web service to legacy application mapping 340 to map the request to the legacy application 350. In accordance with this embodiment, it is not necessary to call web service to legacy application mapping 340 because legacy application programming interface 360 output is available in cache and does not need to be executed. In accordance with another embodiment of the present invention, web service controller 330 determines if legacy application is available in cache after calling web service to legacy application mapping 340 to map the request to the legacy application programming interface 360.

In accordance with another embodiment of the present invention, if legacy application 350 is cacheable, web service controller 330 initiates caching of legacy application 350 in a cache. In accordance with the aspects of the present invention, legacy application 350 can be cached in accordance with any known methods for caching data.

In accordance with an illustrative example of the present invention, web service controller 330 retrieves the output received from legacy application programming interface 360 is retrieved from cache, rather than calling legacy application programming interface 360 to execute legacy application 370. In accordance with another embodiment of the present invention, web service controller 330 calls legacy application output interface 360 to initiate execution of legacy application 350 and return output received from execution of legacy application 350. In this illustrative example, output is dynamically received from legacy application programming interface 360 as a result of executing legacy application 350.

Thus, an output of the legacy application programming interface 360, which is a business logic interface, can be obtained from at least one of a cache. In such a case, the output stored in cache is derived from the business logic interface. If the output of the business logic interface is not available in cache, the output is derived from the business logic interface by executing the legacy application associated with the request, such as XML request 328.

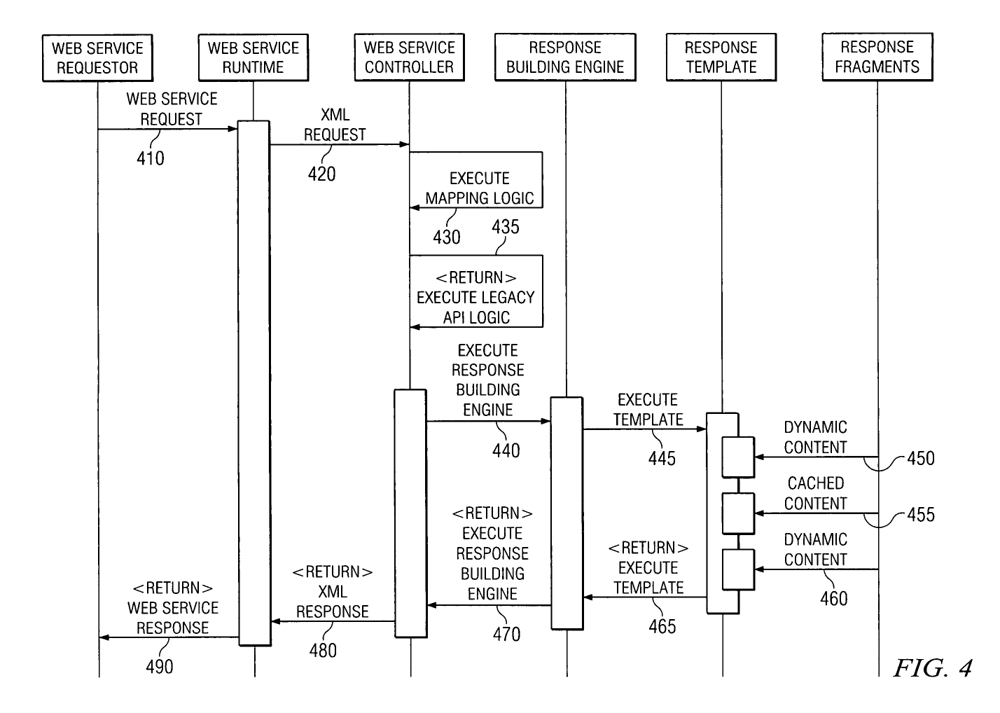

FIG. 4 is an exemplary illustration of a message flow during web service request processing in accordance with one exemplary embodiment of the present invention. The messaging flow in FIG. 4 is implemented within web service server 300 in FIG. 3.

A requestor transmits a web service request 410 to a web service runtime in the form an XML request packaged within a simple object access protocol envelope. Web service runtime removes the simple object access protocol from the XML request and transmits the XML request 420 to web service controller.

Web service controller receives the XML request. Web service controller calls web service to legacy application mapping to execute mapping logic 430. Mapping logic 430 maps the XML request to a legacy application. Mapping logic 430 returns a format for a call to the legacy application programming interface associated with the legacy application.

Web service controller executes legacy application programming interface (API) 435 to initiate execution of the legacy application. Legacy application programming interface returns output from execution of legacy application to web service controller.

Web service controller calls response building engine to execute 440 response building template. Response building engine executes template 445 to generate dynamic content 450 and 460. Response building engine retrieves cached content 455 from cache. Response building engine executes template 465 to generate an XML response based on the cached content and dynamic content. Response building engine returns the XML response to web service controller 470.

Web service controller transmits the XML response 480 to web service runtime. Web service runtime encloses the XML response in a simple object access protocol envelope to form a web service response. Web service runtime transmits the web service response 490 back to the requestor.

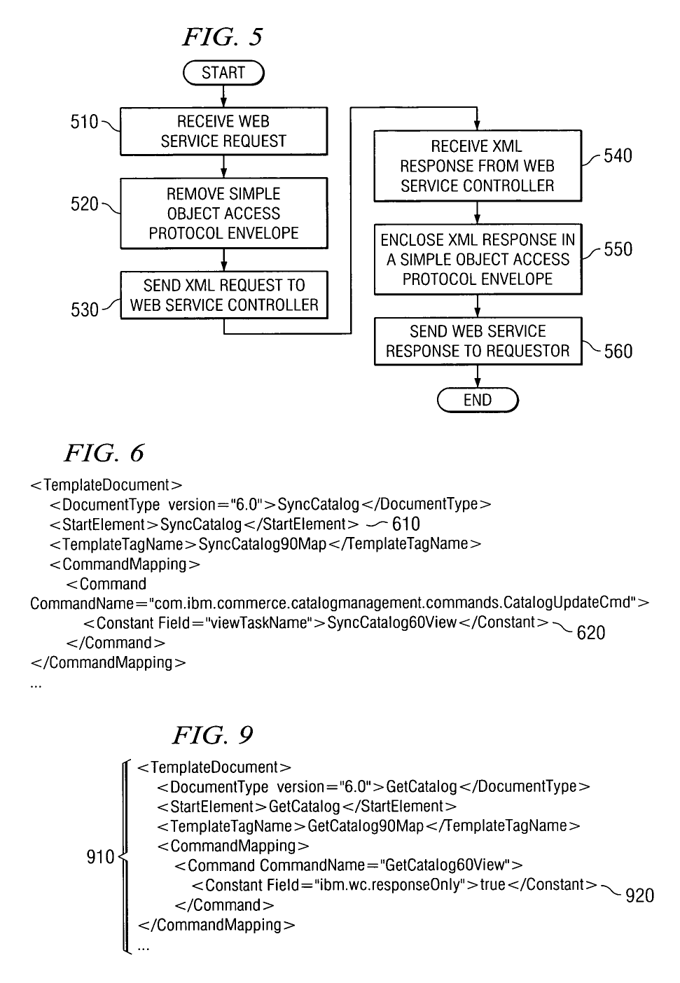

FIG. 5 is a flowchart outlining an exemplary operation of the present invention when a web service request is initially received from a requestor in accordance with one exemplary embodiment of the present invention. The process in FIG. 5 is implemented by web service runtime, such as web service runtime 320 in FIG. 3.

The web service runtime receives a web service request from a requester (step 510). The web service runtime removes the XML request from the simple object access protocol envelope enclosing the XML to form an XML request (step 520). The web service runtime sends the XML request to the web service controller for processing of the request (step 530).

After the web service controller has completed processing of the request, the web service runtime receives the XML response from web service controller (step 540). The web service runtime encloses the XML response in a simple object access protocol envelope (step 550) and sends the web service response to the requester (step 560) with the process terminating thereafter.

FIG. 6 is an exemplary illustration of XML code for mapping a web service request to a legacy application programming interface in accordance with one exemplary embodiment of the present invention. The code implemented in FIG. 6 may be implemented in a mapping component, such as web service to legacy application mapping 340 in FIG. 3.

A web service controller calls a web service to legacy application mapping component to map the web service request to a legacy application programming interface to generate a call to execute the legacy application.

Code 610 is utilized by the mapping component to determine which web service legacy application programming interface to call to execute the legacy application. Line of code 620 specifies a constant called “viewTaskName” which will be defined during mapping. The web service response building engine will use this additional information to build the response. In other words, this configuration code provides a correlation between which application to execute and how to build the response.

For example, when the web service controller calls the mapping component, the mapping component converts the XML request into a set of name-value-pairs. This first set of name-value-pairs is utilized by the legacy application programming interface to execute the legacy application. As a result of execution of the legacy application associated with the legacy application programming interface, a second set of name-value-pairs is generated. The first and second sets of name-value-pairs are passed to the response building engine. The response building engine uses the name-value-pairs as parameters to generate the response to the XML request. However, this is merely one example of an implementation of a mapping function in accordance with an embodiment of the present invention. Any other known or available methods for mapping an XML request onto an interface may be utilized in accordance with the aspects of the present invention.

In response to receiving an XML request, the web service controller calls an interface associated with the request. The web service controller supports a caching function whereby the output of the interface can be stored in a cache if the output is cacheable. Thus, the output of the interface can be obtained by web service controller from a cache.

The web service controller can also determine if the output of the interface is already stored in cache. If the output is absent from cache, the output of interface can be derived from the interface by calling the interface to execute an application, such as legacy application. In response to executing the application, the interface returns output of the interface to web service controller.

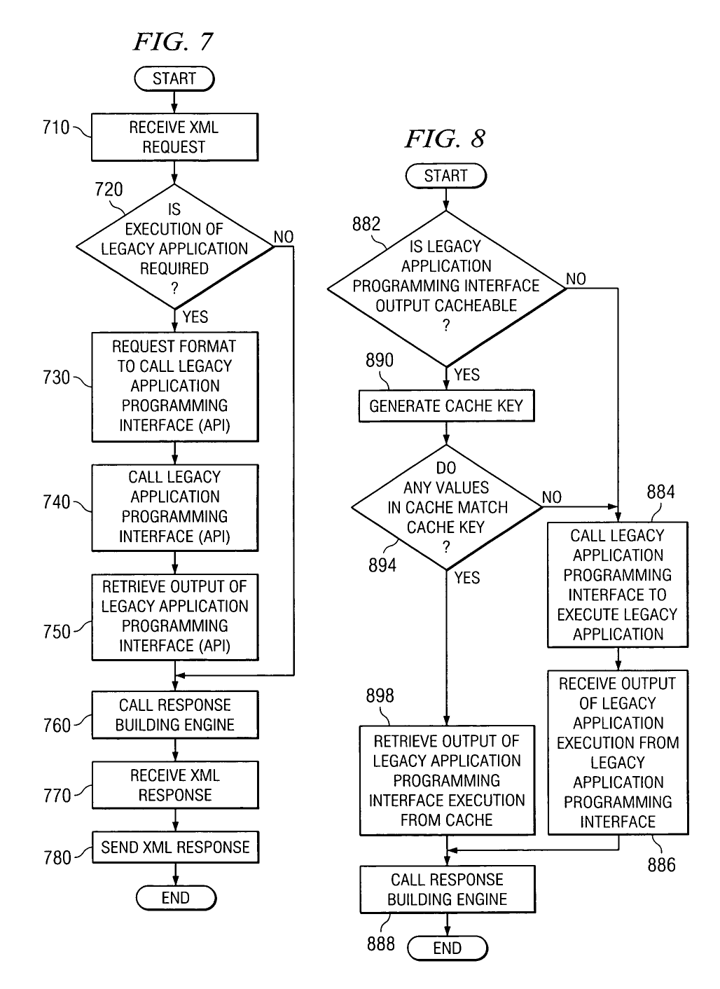

FIG. 7 is a flowchart outlining an exemplary operation of the present invention when a legacy application is executed in accordance with one exemplary embodiment of the present invention. The process in FIG. 7 may be implemented by a web service controller, such as web service controller 330 in FIG. 3.

The web service controller receives an XML request from web service runtime (step 710). The web service controller determines whether execution of the legacy application is required (step 720). For example, if the legacy application programming interface output is available in cache, execution of the legacy application may not be required.

If execution of the legacy application is not required, web service controller calls response building engine to generate an XML response to the request based on the output of the legacy application programming interface (step 760). Web service controller receives the XML response generated by the response building engine (step 770). Web service controller sends the XML response to the web service runtime for transmission back to the requester of the web service (step 780) with the process terminating thereafter.

Returning now to step 720, if execution of the legacy application is required, the web service controller requests a format to call legacy application programming interface to execute the legacy application (step 730). The controller calls the legacy application programming interface to execute the legacy application (step 740).

Web service controller receives output from the legacy application programming interface (step 750). The controller calls the response building engine (step 760). The controller receives the XML response from the application programming interface associated with the response building engine (step 770). The web services controller sends the XML response to the web service runtime (step 680) with the process terminating thereafter.

In accordance with the aspects of the present invention, a determination can be made as to whether the output of a legacy application programming interface is available in cache based upon a cache key. A cache key comprises parameter values defining the type of cacheable data.

For example, if a legacy application is executed to generate campaigns targeted for a thirty year old male, this output from legacy application could be cached by the application programming interface associated with that legacy application. When a second user requests campaigns targeted for a thirty year old male, web service controller generates a cache key with parameters specifying a sex and age, in this case, male and thirty years old.

The cache key also specifies a particular legacy application programming interface in the plurality of application programming interfaces that are utilizing the cache. The parameter values for the cache key are compared to parameters for data in cache until a match is found. Caching of the output of a legacy application programming interface may be accomplished in accordance with any known or available methods for caching data and retrieving data from cache. In accordance with an embodiment of the present invention, a call to legacy application programming interface is not made if the output of the legacy application programming interface is available in cache.

FIG. 8 is a flowchart outlining an exemplary operation of the present invention when a determination is made as to whether to execute legacy application in accordance with one exemplary embodiment of the present invention. The process in FIG. 8 is a more detailed description of step 720 in FIG. 7. The process may be implemented in a web service controller, such as web service controller 330 in FIG. 3.

The web service controller determines whether the output from a legacy application programming interface associated with the legacy application is cacheable (step 882). If the output of the legacy application programming interface is not cacheable, the web service controller calls the legacy application programming interface to execute the legacy application (step 884). The response building engine receives the output of execution of the legacy application from the legacy application programming interface (step 886). The web service controller then calls the response building engine to generate a response to the web service request (step 888). In accordance with this exemplary embodiment, the response is generated based upon the output from the legacy application programming interface (step 888) with the process terminating thereafter.

Returning now to step 882, if the legacy application is cacheable, the controller generates a cache key for the request (step 890). The web service controller then determines if any values for the data available in cache match the cache key (step 894). If no values in cache match the cache key, the web service controller calls the legacy application programming interface to execute the legacy application (step 884). The web service controller receives the output from legacy application programming interface (step 886) and saves the results in cache based upon the generated cache key. The web service controller calls the response building engine (step 888) with the process terminating thereafter.

Returning to step 894, if a value in cache matches the value of the cache key, the controller retrieves the output from the legacy application programming interface from cache (step 898). The web service controller then calls the response building engine to generate a response to the web service request based on the cached output from the legacy application programming interface (step 888) with the process terminating thereafter.

In accordance with an embodiment of the present invention, the response is generated based upon the legacy application programming interface output. However, the response can also be generated based upon other information in addition to, or in place of, the output of the legacy programming interface.

For example, a requestor could request a description of products. In this example, the description of products requested by the requester is available in a database or other data storage device. This type of a request is a “read-only” request that does not require execution of an application and/or generation of an output from an application or application interface in order to generate a response to the request. In this case, the response building engine can simply retrieve the requested information from the database or other data storage location. The response building engine generates a response based on the retrieved data. Therefore, in accordance with the aspects of the present invention, a response may be generated in the absence of any output from the legacy application programming interface and/or the legacy application.

FIG. 9 is an exemplary illustration of XML code when a read-only request is received in accordance with one exemplary embodiment of the present invention. The code implemented in FIG. 9 may be implemented in a response building engine, such as response building engine 370 in FIG. 3.

In some cases, a web service request is a read-only request. For example, a requestor may request a description of catalog items stored in a catalog database. In such a case, execution of the legacy application is not required. Instead, the requested data is merely retrieved from a database and sent to the requester.

Code 910 is an XML configuration used to direct a web service controller to bypass execution of the legacy application because processing of the business logic is not required. Instead, the web service controller is directed to call the response building engine to generate a response to present the requested data. In this illustrative embodiment, instead of creating a do-nothing business logic command to perform the fetch only request or utilizing a dummy command, code 920 specifies a constant “responseonly” to execute the read only request.

In accordance with the aspects of the present invention, a web service controller can retrieve data responsive to a web service request from a variety of different data sources, including but not limited to a database, a read-only memory, a random access memory such as a cache, any other internal data storage device, any external data storage device, or any external system.

In response to receiving an XML request, the response building engine will determine if the web service response to the request is cacheable. If the response is cacheable, response building engine will identify the cacheable fragments in the response. These cacheable fragments form a set of cached content in cache that is responsive to the request. The response building engine identifies a set of cached content in the cache that is responsive to the request to form an identified set of cached content. Response building engine retrieves the identified set of cached content from cache. The response to the request is generated based upon the identified set of cached content such that the response includes the set of cached content.

If the set of cached content is a complete XML response to the request, the customizable template will not be executed. However, if the set of cacheable content is not the entire XML response, a set of template fragments representing the dynamic portions of the response that are not available in cache are identified and executed to generate a set of dynamic content. The set of dynamic content forms a dynamic portion of the response. Thus, a response generated in accordance with this illustrative example will comprise a set of cached content and a set of dynamic content.

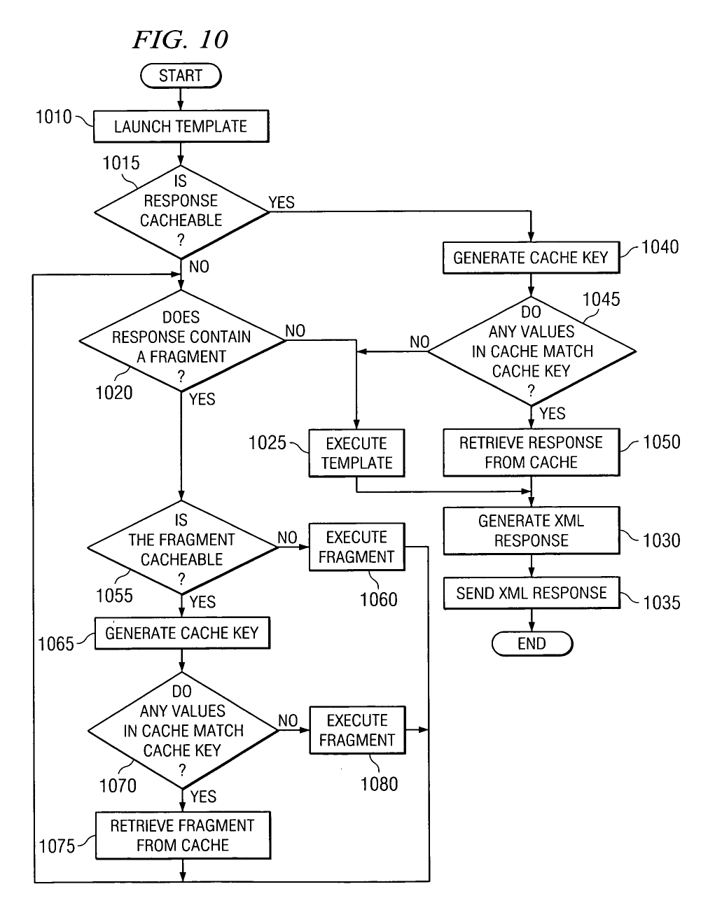

FIG. 10 is a flowchart outlining an exemplary operation of the present invention when a response is generated in accordance with one exemplary embodiment of the present invention. The process is implemented by response building engine 370 in FIG. 3 in the illustrative examples.

Response building engine launches the template to generate a response (step 1010). Response building engine determines if the response is cacheable (step 1015). If the response is not cacheable, response building engine determines if the response contains a fragment (step 1020). If the response does not contain a fragment, the response building engine executes template (step 1025) to generate an XML response (step 1030) to the request. The XML response is sent to the web service controller (step 1035) with the process terminating thereafter.

Returning now to step 1015, if the response is cacheable, the response building engine generates a cache key for the response (step 1040). The response building engine determines whether any values in cache match the value of cache key (step 1045). If no values in cache match cache key, the response building engine executes template (step 1025) to generate an XML response (step 1030) to the request. The XML response is sent to the web service controller (step 1035) with the process terminating thereafter.

Returning now to step 1045, if a value in cache matches cache key, the response building engine retrieves the complete cached response from cache (step 1050) and generates XML response (step 1030). The response generating engine sends the XML response to the web service controller (step 1035) with the process terminating thereafter.

Returning now to step 1020, if the response contains a fragment, the response building engine determines if the response fragment is cacheable (step 1055). If the fragment is not cacheable, the response generating engine executes the fragment of the template (step 1060) associated with the response fragment and returns to step 1020 to determine if response contains another fragment. Steps 1020 and 1055-1080 form an iterative loop that will continue to execute until all of the fragments in the response have been either retrieved from cache or have been generated by executing the template.

Returning now to step 1055, if the response fragment is cacheable, the response generating engine generates a cache key associated with the response fragment (step 1065). The response building engine then determines if any values in cache match the value for the cache key (step 1070). If no values in cache match the cache key, the response building engine executes the template fragment (step 1080) associated with the fragment response. Thus returning the process to step 1020. This iterative loop will continue to execute until all of the response fragments have either been retrieved from cache or have been generated by executing the template fragments associated with the response fragments.

Returning now to step 1070, if a value in cache matches the cache key, the response building engine retrieves the response fragment from cache (step 1075). Thus returning the process to step 1020.

In accordance with one embodiment of the present invention, the response building engine determines if a newly generated response is cacheable. In other words, a determination is made as to whether the response comprises a set of cacheable content. A set of cacheable content could include the entire XML response or one or more portions of the XML response.

If a determination is made that the response does comprise a set of cacheable content, the response building engine will determine if the set of cacheable content is already stored in cache. If the set of cacheable content is not already stored in cache, the response building engine will store the set of cacheable content in cache to form a set of cached content. Cacheable content is stored in cache by the response building engine in accordance with a fragment cache approach. Thus, an entire XML response, a fragment of an XML response, or multiple fragments of the XML response can be cached.

Fragment caching is performed by the response generating engine in accordance with a caching policy. The caching policy, which is defined in the XML configuration for the response building engine template, specifies caching of the XML response. The caching policy defines which fragments are cached and which fragments of the response are dynamically generated by executing the template fragments.

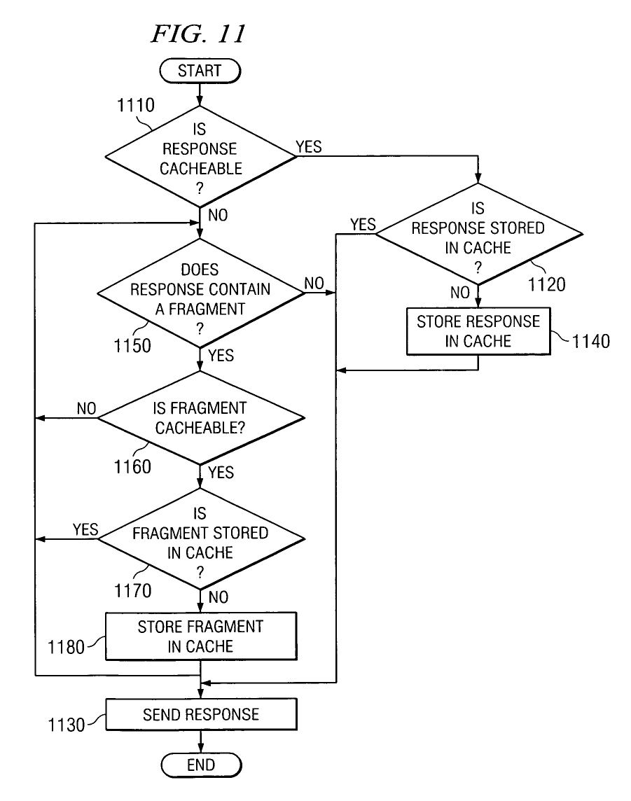

FIG. 11 is a flowchart outlining an exemplary operation of the present invention when a web service response is cached in accordance with one exemplary embodiment of the present invention. In these illustrative examples, the process is implemented by response building engine 370 in FIG. 3.

The response building engine determines if a response is cacheable (step 1110). If the response is cacheable, the response building engine determines if the response is stored in cache (step 1120). If the response is stored in cache, the cached response is sent to web service controller (step 1130) with the process terminating thereafter.

Returning now to step 1120, if the response is not stored in cache, response generating engine stores the response in cache (step 1140) and sends the response to web service controller (step 1130) with the process terminating thereafter.

Returning now to step 1110, if the response is not cacheable, the response building engine determines if response contains a fragment (step 1150). If response does not contain a fragment, the response is sent (step 1130) with the process terminating thereafter.

Returning to step 1150, if the response does contain a fragment, the response building engine determines if the fragment is cacheable (step 1160). If the fragment is not cacheable, the process returns to step 1150. If the fragment is cacheable, the response building engine determines if the fragment is stored in cache (step 1170). If the fragment is stored in cache, the process returns to step 1150. If the fragment is not stored in cache, the fragment is stored in cache (step 1180). The process then returns to step 1150.

Steps 1150-1180 form an iterative loop that will continue to execute until all of the cacheable fragments in the response have been stored in cache.

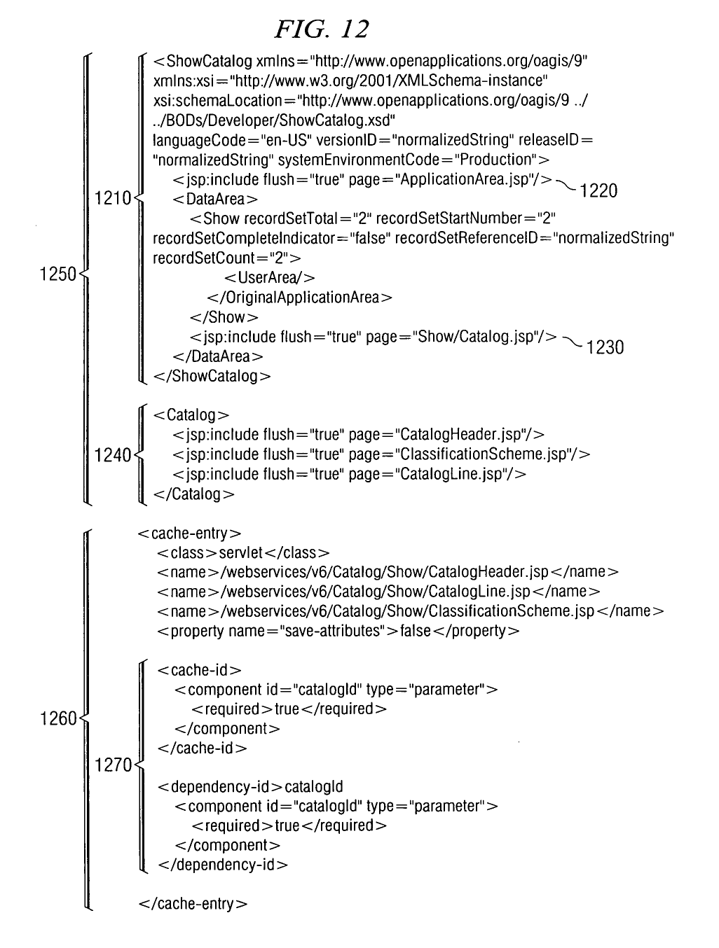

FIG. 12 is an exemplary illustration of XML code when a response is generated utilizing fragment caching in accordance with one exemplary embodiment of the present invention. Code 1210 is an example of an XML configuration for a fragment caching approach for a web service response. Code 1210 and 1240 comprise an XML code for a response building engine 1250.

In code 1210, two separate JavaServer® Pages fragments are included in the response. Line of code 1220 is an “ApplicationArea.jsp” fragment which is a common application area. This application area can be reused in other web service responses, as shown at line of code 1220. The other JavaServer® Pages fragment is “Show/Catalog.jsp” at line of code 1230. This code directs the template language to include a catalog fragment from cache in a web service response.

Within the “Show/Catalog.jsp fragment shown in line of code 1230, there are three XML blocks, which are shown in code 1240. Each XML block is represented by a JSP fragment. Either some or none of the Java® Server Page fragments shown in code 1240 are cacheable.

For the fragments that are cacheable, the caching policy can be created to cache the content so that the next time the JavaServer® Pages fragment is rendered, the cache version can be used. Code 1260 shows an example of such a policy.

Within the cache policy definition, all three fragments in code 1240 are cacheable based upon the “cataloged” parameter found in the request, as shown in code 1270. The “catalogId” will either be the one returned by the command executed by the service or the parameter mapping out of the XML service request.

As shown in code 1260, the first time the response of the service with catalogId 123 is executed, each JavaServer® Pages will be executed as well. However, the three fragments will also be cached at the same time. The next time another request is received that includes the same JavaServer® Pages fragments for catalogId 123, the cached version of the fragments will be returned instead of executing the template language to generate the fragment.

The aspects of the presently claimed invention provide an improved method for caching web service responses. Multiple cache points are provided during processing of a web service request and generation of a web service response. The output generated by execution of the web service legacy application can be dynamically provided by the legacy application programming interface or the output can be retrieved from a cache.

In addition, the response template executed to generate the XML response to a web service request can also be cached. Moreover, this template supports fragment caching. Therefore, the response can be cached in its entirety, as a complete response. In the alternative, one or more fragments of the response can be cached. Finally, the template permits easy customization and modification of the template and the caching policy utilized to generate a response in accordance with the embodiments of the present invention.

In this manner, the aspects of the present invention provide full and partial caching of a web service response, rather than being limited to an all-or-nothing approach to caching responses. Moreover, the embodiments of the present invention also provide the ability to easily customize how the response is generated by modifying a template text file.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for generating a response to a web service request from a requester, the computer implemented method comprising:
responsive to receiving a web service request, calling a business logic interface associated with the request;
executing a customizable template to generate the response to the request;
determining whether the response comprises a set of cacheable content;
responsive to a determination that the response comprises a set of cacheable content, storing the set of cacheable content in the cache; and
sending the response to the requester.

2. The computer implemented method of claim 1 wherein an output of the business logic interface is obtained from at least one of a cache, and derived from the business logic interface.

3. The computer implemented method of claim 1 wherein the executing of a customizable template step further comprises:
determining whether the response is cacheable;
responsive to determining the response is cacheable, identifying a set of cached content in the cache, wherein the cached content is responsive to the request; and
retrieving the identified set of cached content, wherein the response comprises the identified set of cached content.

4. The computer implemented method of claim 3 further comprising:
executing a set of template fragments to generate a set of dynamic content, wherein the set of dynamic content forms a dynamic portion of the response, and wherein the response comprises the set of cached content and the set of dynamic content.

5. The computer implemented method of claim 1 wherein the customizable template is not executed responsive to a determination that a complete response to the request is stored in the cache.

6. The computer implemented method of claim 1 wherein the business logic interface is an application programming interface associated with a web service application, and the response is generated based upon the output of the application programming interface.

7. The computer implemented method of claim 1 further comprising:
mapping the web service request onto a web service application to generate a call on the business logic interface.

8. The computer implemented method of claim 1 wherein the output of the business logic interface is stored in the cache responsive to a determination that the output is cacheable.

9. The computer implemented method of claim 1 further comprising:
modifying a content of the response by updating a text file representing the customizable template.

10. The computer implemented method of claim 1 wherein a caching policy specifying caching of the response is modified by updating a text file representing the template.

11. The computer implemented method of claim 1 wherein the cacheable content is stored in the cache in accordance with a fragment caching approach.

12. A computer program product comprising:
a computer usable medium including computer usable program code for generating a response to a web service request from a requester, said computer program product comprising:
computer usable program code responsive to receiving a web service request, for calling a business logic interface associated with the request;
computer usable program code for executing a customizable template to generate the response to the request;
computer usable program code for determining whether the response comprises a set of cacheable content; and
computer usable program code for storing the set of cacheable content in the cache in response to determining that the response comprises a set of cacheable content;
computer usable program code for sending the response to the requester.

13. The computer program product of claim 12 wherein an output of the business logic interface is obtained from at least one of a cache, and derived from the business logic interface.

14. The computer program product of claim 12 further comprising:
computer usable program code for determining whether the response is cacheable;
computer usable program code for identifying a set of cached content in the cache in response to determining that the response is cacheable, wherein the cached content is responsive to the request; and
computer usable program code for retrieving the identified set of cached content, wherein the response comprises the identified set of cached content.

15. The computer program product of claim 14 further comprising:
computer usable program code for executing a set of template fragments to generate a set of dynamic content, wherein the set of dynamic content forms a dynamic portion of the response, and wherein the response comprises the set of cached content and the set of dynamic content.

16. The computer program product of claim 12 wherein the customizable template is not executed responsive to a determination that a complete response to the request is stored in the cache.

17. The computer program product of claim 12 wherein the cacheable content is stored in the cache in accordance with a fragment caching approach.

18. The computer program product of claim 12 further comprising:
computer usable program code for modifying a content of the response by updating a text file representing the customizable template.

19. The computer program product of claim 12 wherein a caching policy specifying caching of the response is modified by updating a text file representing the template.

20. A system for generating a response to a web service request from a requestor, comprising:
a web service controller, wherein the web service controller calls a business logic interface associated with the request in response to receiving the web service request, and wherein an output of the interface can be obtained from at least one of a cache, and derived from the interface;
a response building engine, wherein the response building engine executes a customizable template to generate the response to the request; determine whether the response comprises a set of cacheable content; store the set of cacheable content in the cache in response to determining that the response comprises a set of cacheable content; and
a web service runtime, wherein the web service runtime sends the response to the requester.
